(19) United States
(12) Patent Application Publication
(10) Pub. No.: US 2003/0046188 A1
(43) Pub. Date: Mar. 6, 2003

(54) System and method for aiding consumer grocery product purchase decisions

(76) Inventor: Genaro Antonio Fernandez Orozco, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/943,041

(22) Filed: Aug. 30, 2001

(51) Int. Cl. G06F 17/60

(52) U.S. Cl. 705/27; 705/9

(57) ABSTRACT

The present invention is related to a system and method for aiding a consumer's purchasing decisions related to grocery products. In particular, a display and an input interface are provided at a point-of-sale location. A processor is provided to prompt a user for input parameters related to consumer recipe preferences via the display. The processor receives the input parameters from the input interface. The processor queries a recipe database utilizing the input parameters. The processor identifies grocery products of a recipe identified by the database query. The processor further obtains and provides price information related to the grocery products to the consumer.

### TECHNICAL FIELD

The present invention is generally related to kiosk to provide recipe information and more particularly to a kiosk that provides recipe information to consumer at a point-of-sale location in response to recipe query parameters.

### BACKGROUND

At the present time, many individuals have begun to rely on prepared meals due to the pace of modern society and due to the convenience of pre-prepared food. Many business professionals typically stop at various take-out restaurants on their way home from work. However, repeatedly dining at nondescript chain restaurants can be quite fatiguing due to the homogenous nature of chain restaurants. Specifically, it can be quite difficult to find a restaurant that provides anything unique. However, many individuals are hesitant to attempt to cook for themselves due to their lack of experience with cooking.

Obviously, cookbooks offer a solution to this problem. However, cookbooks do not provide the convenience that many time-pressed individuals require. Some amount of preparation and planning is required to prepare a meal according the instructions set forth in a cookbook. In particular, an individual must know exactly which products to purchase before attempting to prepare any particular dish.

### SUMMARY OF THE INVENTION

The present invention is directed to a system and method for aiding a consumer's purchasing decisions related to grocery products. In particular, a display and an input interface are provided at a point-of-sale location. A processor is provided to prompt a user for input parameters related to consumer recipe preferences via the display. The processor receives the input parameters from the input interface. The processor queries a recipe database utilizing the input parameters. The processor identifies grocery products of a recipe identified by the database query. The processor further obtains and provides price information related to the grocery products to the consumer.

### BRIEF DESCRIPTION OF THE DRAWING

FIGS. 1-11 depict exemplary kiosk display screens associated with receiving consumer input and providing recipe information in response to the consumer input.

FIG. 12 depicts a block diagram of a recipe kiosk according to embodiments of the present invention.

### DETAILED DESCRIPTION

The present invention is related to kiosk to provide cooking recipes to aid purchasing decisions of busy consumers at point-of-sale locations. Point-of-sale location is defined to mean a location that is publically accessible where purchase of particular products may be made. The point-of-sale location may be associated with a physical store. Alternatively, the point-of-sale location may be associated with a website where purchases may be completed. Embodiments of the present invention provide a touchable screen interface to allow consumers to enter one or several query parameters to obtain a number of potential recipes. The consumers may print the recipes. Additionally, the location of the ingredients within the store may be provided via a store map. Moreover, the total price of the necessary ingredients may be provided to aid budgeting decisions. Likewise, coupons for particular brands may be supplied or substitute ingredients may be supplied to aid consumers who possess budget constraints.

In embodiments of the present invention, the recipe information is provided to a consumer at a kiosk located in a central portion of a grocery store. The kiosk may include a magnetic stripe reader to accept a “frequent customer card.” The frequent customer card may be utilized to track consumer purchasing decisions by storing purchase information in a store server. This may allow the kiosk to obtain relevant information about previous customer purchases to aid the selection of desirable recipes. For example, consumer information may indicate that a particular consumer frequently purchases microwaveable products. It may be inferred that the consumer may prefer meals that require relatively less preparation time. Accordingly, recipe search results may be ordered for this consumer by the amount of preparation time (i.e., those recipes requiring the least amount of preparation are shown first). However, it is advantageous to not omit any recipes on the basis of purchase information, since a consumer may be intentionally trying to break from traditional meals by utilizing the recipe kiosk. Although, in certain embodiments, the kiosk is located at a stored location, the present invention is not limited to any particular location. Embodiments of the present invention can provide recipe information to a consumer at any point of sale location. For example, the point of sale location could be an Internet website where a consumer can order groceries for delivery to the consumer's home.

The kiosk may present an initial screen to allow a consumer to access the various recipes. For example, the kiosk may allow a consumer to browse as desired. In embodiments of the present invention, the kiosk accepts a series of input parameters to perform a database search to facilitate the consumer's search.

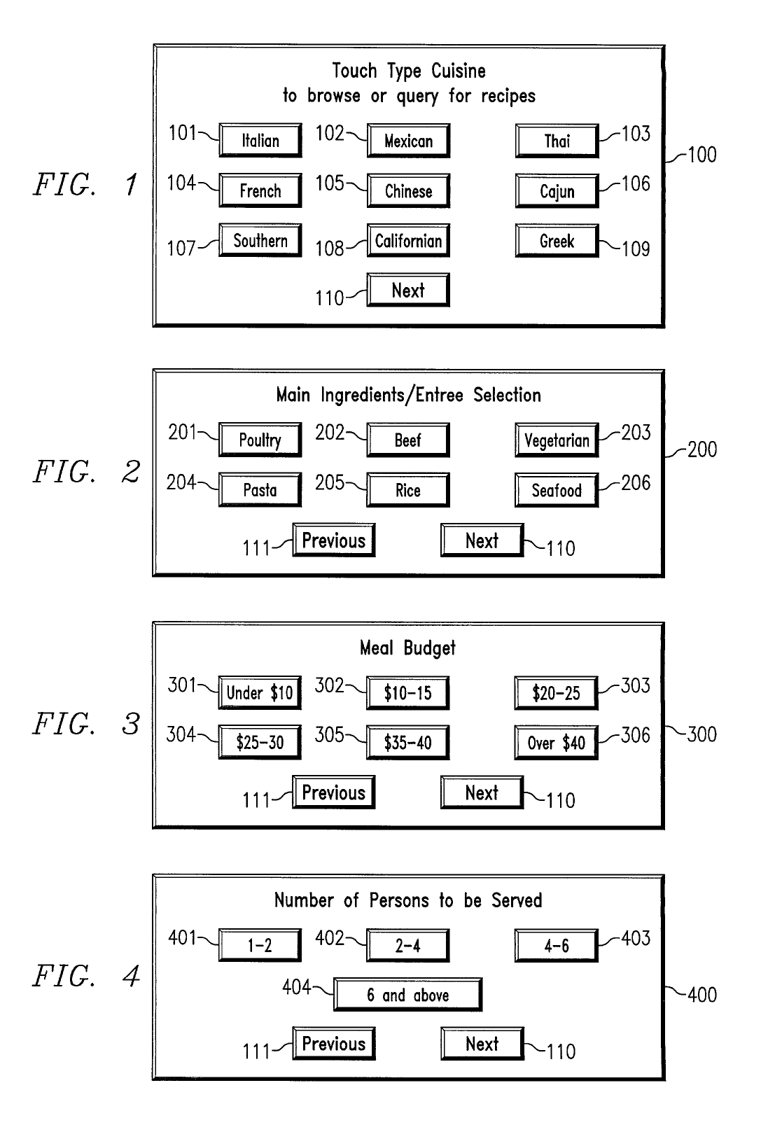

FIGS. 1-11 depict exemplary screen displays according to embodiments of the present invention which utilize such a series of input screens. The exemplary screens may be displayed by a kiosk. Alternatively, the screens may be displayed on an Internet browser.

FIG. 1 depicts introductory screen 100. Introductory screen 100 provides a plurality of input selection icons 101-109 prompting the user to select between various types of cuisine such as Italian, Mexican, Thai, and/or the like. Of course, any number of cooking styles may be offered. In addition to types of cuisines, other pertinent information can be gathered at screen 100. For example, options can be displayed to indicate a preference for meals that satisfy kosher or vegan requirements. Options can be provided for health concerns such as meals suitable for individuals possessing high blood pressure. Options can be provided for special occasions such as Thanksgiving, Passover, and/or the like. The consumer may select none, one, or several options. Introductory screen 100 further includes a navigational icon 110 which allows the consumer to move on to the next screen when the consumer is finished selecting cuisine types.

Screen 200 of FIG. 2 includes a plurality of selection icons 201-206 prompting the user to select main ingredients or entree selections (such as poultry, beef, vegetarian, pasta, rice, seafood, and/or the like). The consumer may select none, one, or several options. Screen 200 further comprises a plurality of navigational icons 110, 111 allowing the consumer to go back to the previous screen or move on to the next screen.

Screen 300 of FIG. 3 includes a plurality of selection icons 301-306 prompting the user to specify a budget range for the particular meal ranging, for example, from under $5.00 to over $40.00. The consumer may select none, one, or several options. Screen 300 further comprises a plurality of navigational icons 110, 111 allowing the consumer to go back to the previous screen or move on to the next screen.

Screen 400 of FIG. 4 includes a plurality of selection icons 401-404 prompting the user to specify the number of persons to be served for a particular meal. The consumer may select none, one, or several options. Screen 400 further comprises a plurality of navigational icons 110, 111 allowing the consumer to go back to the previous screen or move on to the next screen.

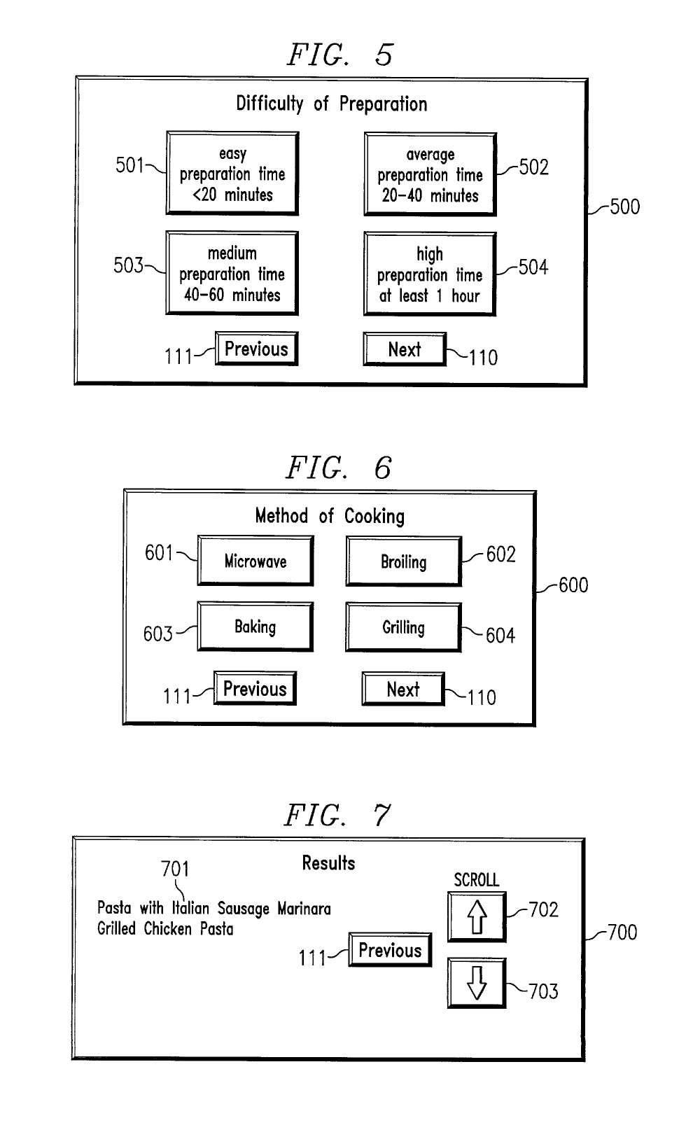

Screen 500 of FIG. 5 includes a plurality of selection icons 501-504 prompting the user to specify the level of difficulty of the preparation of recipe. Screen 500 further includes navigation icons 110, 111 the consumer to go back to the previous screen or move on to the next screen.

Screen 600 of FIG. 6 includes a plurality of selection icons 601-604 prompting the user to specify preferred cooking methods (e.g., broiling, baking, grilling, microwaving, and/or the like). Screen 600 further includes navigation icons 110, 111 the consumer to go back to the previous screen or move on to the next screen.

After receiving the various consumer selections, the kiosk performs a database query utilizing the selections as query parameters. The kiosk may query a database at a particular store location. Alternatively, the kiosk may query a webserver database via the Internet. The kiosk provides a list of recipes to the customer which satisfy the various selections. For example, the kiosk may display list 701 of recipe titles with short descriptions as depicted in screen 700 of FIG. 7. The kiosk may make available all recipes which match entered criteria. Depending upon the input parameters, the number of recipes may be quite large. Accordingly, the consumer can scroll up and down through the list utilizing scroll icons 702, 703. Additionally, the list is advantageously ordered or sorted by specific criteria. For example, the list may be sorted by entree selection or cuisine type. The list may also be sorted by criteria inferred from previous purchase information obtained by a frequent purchaser card as discussed above. When the consumer locates a desired recipe, the consumer may select the recipe's title which will act as a hyperlink.

By selecting a recipe hyperlink, the kiosk may display the selected recipe as depicted by screen 800 in FIG. 8. The recipe, of course, provides detailed directions 801 for making a particular meal including various appetizers and side dishes if desired. The consumer may utilize scroll icons 702, 703 to move forward or backward through the recipe. Additionally, the consumer may print the recipe to take a hard copy with the consumer by selecting print icon 802. Additionally, the consumer may go back to the previous screen via navigational icon 111 to select other recipes as desired. The consumer may select price icon 803 to obtain price information.

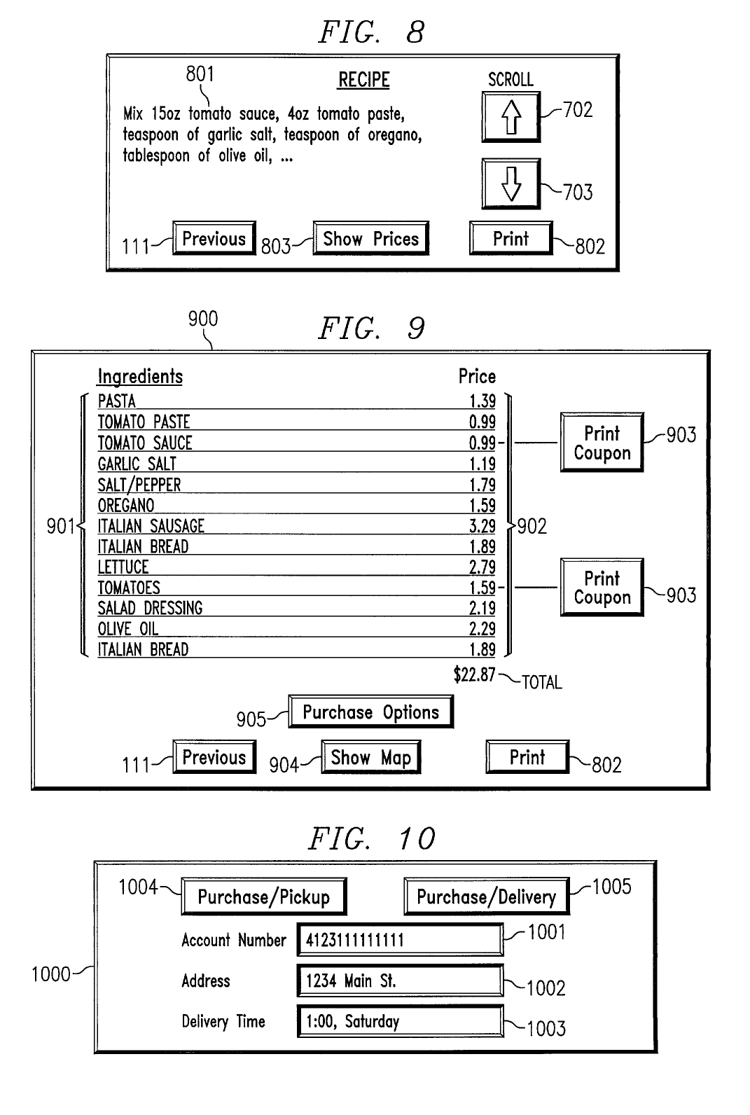

Screen 900 of FIG. 9 displays ingredients 901 of the recipe with current price information 902 of the particular items for the quantities specified in the recipe. Additionally, substitute ingredients and/or alternative brands may also be provided to allow the consumer to select more economical ingredients if desired. The kiosk may be communicatively coupled to the store's server. The kiosk may dynamically obtain pricing information 902 from the store's server to provide this information. Also, the kiosk may indicate sales prices may changing the color of price information. For example, prices in red may indicate a special price. Alternatively, screen 900 may provide coupon icons 903 which when selected cause the kiosk to print a coupon for a particular ingredient. By doing so, the kiosk may encourage the consumer to purchase a particular brand of the respective ingredient. Screen 900 further provides print icon 802 to allow the consumer to print the screen. Also, the consumer may select navigational icon 111 to go back to the previous screen. The consumer may select icon 904 to show a store map icon. The consumer may also select purchase options icon 905.

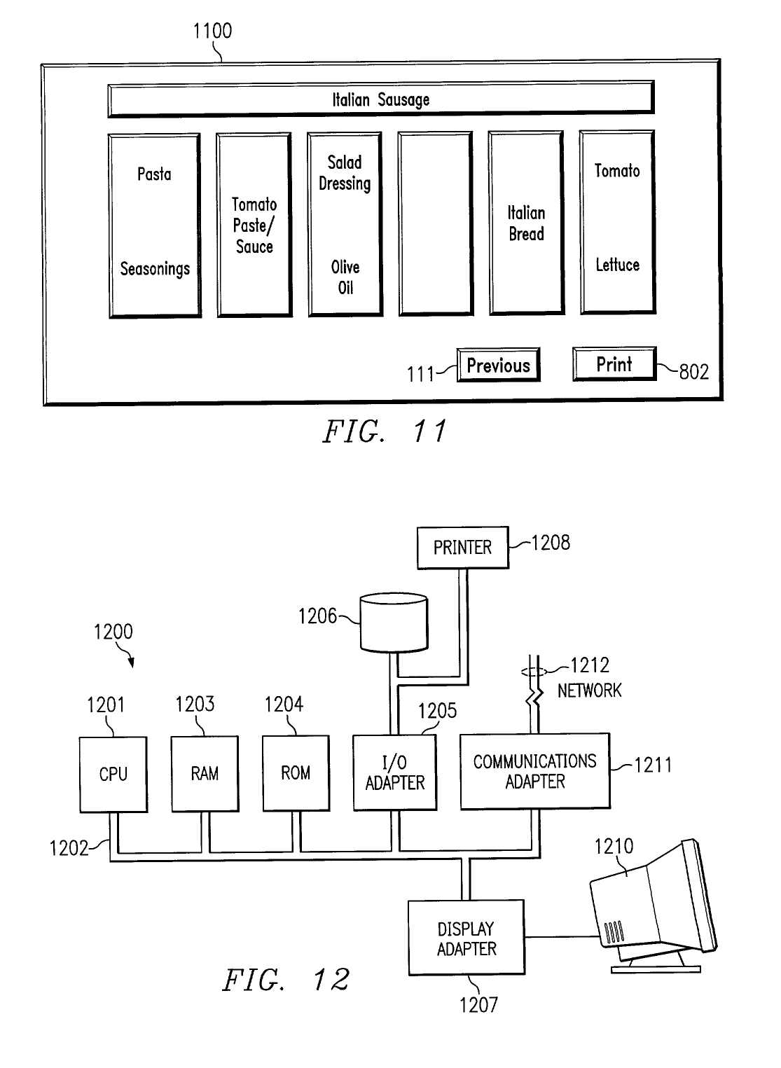

Screen 1000 of FIG. 10 may be displayed when a consumer selects purchase option icon 905 of screen 900. For example, a consumer may select purchase/pick up icon 1004. This icon may allow a consumer to pay for the various ingredients immediately utilizing the account number control 1001. This may generate an order to cause the employees of a particular store to gather the various ingredients to be picked up by the consumer at a later time. Alternatively, the consumer may have the various products delivered to the consumer's address by utilizing purchase/delivery icon 1005, address control 1002, and delivery time control 1003.

Screen 1100 of FIG. 11 provides a map of the store location. Additionally, screen 1100 may provide location information for each of ingredients of the recipe to allow consumers to locate the ingredients with relative ease. The location of ingredients may be retained in a store database. The location information may be maintained by manual data-entry or may be updated utilizing bar-code scanning equipment. The consumer may select print icon 802 to obtain a hard copy of the screen. The consumer may also select navigational icon 111 to return to the previous screen.

It shall be appreciated that screens 100-1100 are merely exemplary. Any other screen formats or content may be utilized as desired. For example, nutritional information (calories, cholesterol content, sodium content, and/or the like) for various ingredients may be provided. Additionally, any other recipe query parameters may be utilized. For example, a consumer may provide keywords to perform recipe searches if the consumer already knows the general type of cuisine that the consumer wishes to prepare. Additionally, the kiosk may display the recipes in a book like fashion. The consumer may scroll from screen to screen in much the same manner as thumbing through a cookbook until the consumer locates a desired recipe. At that point, price and location information may be provided to the consumer.

When implemented via executable instructions, various elements of the present invention are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 12 illustrates a block diagram of recipe kiosk 1200 according to embodiments of the present invention. Central processing unit (CPU) 1201 is coupled to system bus 1202. CPU 1201 may be any general purpose CPU. Suitable processors, without limitation, include any processor from the Itanium™ family of processors, such as the McKinley processor, available from Hewlett-Packard Company, or an PA-8500 processor also available from Hewlett-Packard Company. However, the present invention is not restricted by the architecture of CPU 1201 as long as CPU 1201 supports the inventive operations as described herein. Recipe kiosk 1200 also includes random access memory (RAM) 1203, which may be SRAM, DRAM, or SDRAM. Recipe kiosk 1200 includes ROM 1204 which may be PROM, EPROM, or EEPROM. RAM 1203 and ROM 1204 hold user and system data and programs as is well known in the art.

Recipe kiosk 1200 also includes input/output (I/O) controller adapter 1205, communications adapter 1211, and display adapter 1207. I/O adapter 1205 connects to storage devices 1206, such as one or more of hard drive, CD drive, floppy disk drive, tape drive, to the computer system. Such storage peripherals may be utilized to contain the database information associated with the recipes to allow database queries by the various desired criteria. Additionally, I/O adapter 1205 may connect to printer 1208 to allow the consumer to obtain hard copies of desired recipe information. In an alternative embodiment, I/O adapter 1205 may be coupled to a wireless port to allow consumers to upload recipe information into a personal data assistant (PDA) to retain their own files of the recipe information.

Communications adapter 1211 is adapted to couple the recipe kiosk 1200 to a network 1212, which may be one or more of telephone network, local (LAN) and/or wide-area (WAN) network, Ethernet network, and/or Internet network. Recipe kiosk 1200 may utilize communications adapter 1211 to communicate with a store server to obtain price information. Also, recipe kiosk 1200 may utilize communications adapter 1211 to download new recipes from a central recipe server via the Internet. Display adapter 1207 is driven by CPU 1201 to control the display on display device 1210. Also, display adapter 1207 obtains input information from the touchable screen of display device 1210.

What is claimed is:

1. A system for aiding a customer's purchasing decisions related to grocery products, comprising:
a display unit associated with a point-of-sale location to display information to a consumer;
at least one input interface associated with said display unit to receive information from a consumer; and
said system possessing a processor executing instructions controlling said display unit and said input interface, said instructions including:
(i) code for receiving at least one recipe query parameter indicative of recipe preferences of said consumer;
(ii) code for querying a database of recipes utilizing said at least one recipe query parameter to obtain at least one query result recipe;
(iii) code for identifying grocery products associated with said at least one query result recipe; and
(iv) code for providing price information pertaining to said grocery products to said consumer.

2. The system of claim 1 wherein said instructions further include:
code for receiving purchase information from said consumer.

3. The system of claim 2 wherein said instructions further include:
code for receiving delivery information from said consumer.

4. The system of claim 1 wherein said point-of-sale location is associated with a webserver.

5. The system of claim 1 wherein said instructions further include:
code for providing a map identifying locations where said grocery products are located.

6. The system of claim 1 wherein said code for receiving at least one recipe query parameter obtains a meal budget input parameter.

7. The system of claim 1 wherein said code for receiving at least one recipe query parameter obtains a cuisine type parameter.

8. The system of claim 1 wherein said code for receiving at least one recipe query parameter obtains a main ingredient parameter.

9. The system of claim 1 wherein said code for receiving at least one recipe query parameter obtains a parameter related to difficulty of preparation.

10. The system of claim 1 wherein said code for receiving at least one recipe query parameter obtains a parameter related to method of preparation.

11. The system of claim 1 further comprising:
a printer; and
said instructions further including code for printing said at least one query result recipe in response to input from said customer via said at least one input interface.

12. The system of claim 1 further comprising:
a printer; and
said instructions further including code for printing a coupon to encourage said consumer to purchase a specific brand of a grocery product of said grocery products.

13. The system of claim 1 further comprising:
a magnetic stripe reader to receive a frequent purchaser card; and
said instructions further including code for querying a store server which maintains records indicative of prior consumer purchases, and code for sorting recipe query results in response to prior customer purchases.

14. The system of claim 1 further comprising:
an output interface; and
said instructions further including code for allowing said consumer to download said at least one query result recipe to a personal data assistant via said output interface.

15. The system of claim 1 wherein said at least one input interface is a touch screen.

16. A method for assisting a consumer in making purchasing decisions for grocery products, comprising:
providing a display associated with a point-of-sale location;
prompting a user for at least one desired recipe characteristic via said display;
receiving input in response to said prompting via an input peripheral;
querying a recipe database to identify at least one recipe matching said at least one desired recipe characteristic;
providing said recipe to said consumer;
querying a price database to determine price information associated with said recipe; and
providing said price information to said consumer.

17. The method of claim 16 further comprising:
providing a map including location information pertaining to ingredients of said at least one recipe.

18. The method of claim 16 further comprising:
printing a coupon for a particular brand of an ingredient of said at least one recipe.

19. The method of claim 16 wherein said step of prompting includes requesting a meal budget parameter.

20. The method of claim 16 wherein said step of prompting includes requesting a cuisine type parameter.

21. The method of claim 16 further comprising:
reading a magnetic stripe of a frequent shopper card;
retrieving previous purchase information of said consumer; and
sorting presentation of recipes to said consumer by correlating to said previous purchase information.

22. A point-of-sale kiosk for providing purchasing information to a consumer, comprising:
means for prompting a consumer for recipe parameters;
means for matching said recipe parameters to a database of recipes to generate result recipes;
means for providing said result recipes to said user; and
means for providing price information associated with recipes to said consumer.

23. The point-of-sale kiosk of claim 22 wherein said means for providing said result recipes sorts said recipes in accordance with previous purchases by said consumer.

24. The point-of-sale kiosk of claim 22 wherein said means for providing price information includes a prompt to print a coupon.
